(19) United States
(12) Patent Application Publication
(10) Pub. No.: US 2006/0073121 A1
(43) Pub. Date: Apr. 6, 2006

(54) Spray formulation for pungency enhancement in Capsicum

(76) Inventors: Narasimha Prasad Bellur Chayapathy, Mysore (IN); Giridhar Parvatam, Mysore (IN); Vinod Kumar, Mysore (IN); Gokare Aswathanarayana Ravishankar, Mysore (IN)

Correspondence Address: FROMMER LAWRENCE & HAUG, 745 FIFTH AVENUE- 10TH FL., NEW YORK, NY, 10151, US

(21) Appl. No.: 10/955,786

(22) Filed: Sep. 30, 2004

(51) Int. Cl. A01N 63/04; A01N 63/00

(52) U.S. Cl. 424/93.5; 424/760; 504/117

(57) ABSTRACT

A method of preparation of spray formulation useful for improvement of pungency levels of Capsicum at field level is disclosed. The said spray applied to the Capsicum plants provides an enhanced pungency levels with respect to the levels of Capsaicinoids and also the intermediates of the Capsaicinoids biosynthesis. Said spray formulation involves the extractions of some selected microbial cultures.

### INCORPORATION BY REFERENCE

Each document cited in this text (“application cited documents”) and each document cited or referenced in each of the application cited documents, and any manufacturer's specifications or instructions for any products mentioned in this text and in any document incorporated into this text, are hereby incorporated herein by reference; and, technology in each of the documents incorporated herein by reference can be used in the practice of this invention.

It is noted that in this disclosure, terms such as “comprises”, “comprised”, “comprising”, “contains”, “containing” and the like can have the meaning attributed to them in U.S. Patent law; e.g., they can mean “includes”, “included”, “including ”. and the like. Terms such as “consisting essentially of” and “consists essentially of ” have the meaning attributed to them in U.S. Patent law, e.g., they allow for the inclusion of additional ingredients or steps that do not detract from the novel or basic characteristics of the invention, i.e., they exclude additional unrecited ingredients or steps that detract from novel or basic characteristics of the invention, and they exclude ingredients or steps of the prior art, such as documents in the art that are cited herein or are incorporated by reference herein, especially as it is a goal of this document to define embodiments that are patentable, e.g., novel, nonobvious, inventive, over the prior art, e.g., over documents cited herein or incorporated by reference herein. And, the terms “consists of” and “consisting of” have the meaning ascribed to them in U.S. Patent law; namely, that these terms are closed ended.

### FIELD OF INVENTION

This invention relates to spray, methods of producing and formulating the spray and means of using the spray as an elicitation agent. In particular, this invention relates to the novel improvements of pungency factors of Capsicum in particular the capsaicinoids and intermediates of phenyl propanoid pathway leading to capsaicinoid biosynthesis.

### BACKGROUND AND PRIOR ART

Chilli (Capsicum spp.) is one of the major economical crops of Solanaceae grown for its pungency and carotenoid pigments. It is well documented that the pungency of Capsicum is due to capsaicinoids majority of which are capsaicin and dihydrocapsaicin (Kaale, E., Ann Van Schepdael, Eugene Roets and Jos Hoogmartens. 2002. Determination of Capsaicinoids in topical cream by liquid-liquid extraction and liquid chromatography. J. Pharm Biomed Anal. 30:1331). Capsaicin is also used in pharmaceuticals, cosmetics, food and drinks (Mathur, R., Dangi, R. S., Dass, S. C. and Malhotra, R. C. 2000. The hottest chilli variety in India. Curr. Sci. 79(3): 287).

Capsaicin provides a hot, spicy, pungent flavour as well as a numbing, burning or tingling effect when applied orally or topically. Capsaicin is known to be a powerful irritant that can cause selective degeneration of sensory neurons that mediate chemogenic or trigeminal pain. Capsaicin and its derivatives are principally used as an irritant; a flavorant from about 1 part in 100,000 parts; an animal repellent (U.S. Pat. Nos. 5,322,862 and 5,456,916); an antifoulant (U.S. Pat. No. 5,397,385); an aversive agent (U.S. Pat. No. 5,891,919) a carminative; in neural biological research (U.S. Pat. No. 5,094,782) and in pharmaceuticals (U.S. Pat. No. 5,403,868). Both the natural and synthetic compounds of capsaicin have been found to be very effective for these uses.

India is among the top exporters of whole Chillies and oleoresins. Oleoresin Capsicum has found increasing industrial use in the place of ground Chillies and is used in pharmaceuticals, food industry and beverages. Though the genetic variability with respect to pungency is wide and large numbers of varieties and hybrids have been released by many organizations, very little effort has been made to increase the capsaicin content in the Chilli fruit (Tewari, V. P. 1990. Development of high Capsaicin Chillies (Capsicum annuum L.) and their implications for the manufacture of export products. J. Plantation Crops. 18(1): 1). High pungency oleoresins of 5,00,000 to 1,00,000 Scoville heat units are used in both foods and pharmaceuticals (A. G. Mathew, Lewis, J. S, Jagadishan, E. S, Nambudiri, E. S and Krishnamurhty, N. 1971. Oleoresin Capsicum. The flavor Industry. 2(1): 23-26.) Hence there is a need to enhance constituents of Capsaicinoids to meet the requirement of oleoresin industry. One of the basic requirements to increase Capsaicin content in chilli cultivars is to identify the germplasm having high capsaicin content.

Plant cell culture is an alternative technology for the production of high value phytochemicals. Elicitation of secondary metabolites by using fungal, bacterial and yeast origin have been known (Dicosmo and Misawa 1985. Elicitation of secondary metabolism in plant cultures Trend in Biotechnology 3: 318; Sudhakar Johnson, T., Ravishankar G. A and Venkatraman L. V. 1993. Elicitation of capsaicin production in freely suspended cells and immobilized cell cultures of Capsicum frutescens Mill. Food Biotechnol. 5: 197).

Capsaicinoids are biosynthesized by enzymatic condensation of Vanillylamine with a short chain branched fatty acid by putative Capsaicin synthase. Evidence for the possible biosynthetic pathway leading to Capsaicin biosynthesis includes radiotracer studies (Fujiwake, H., Suzuki, T and Iwai. 1982. Intracellular distribution of enzymes and intermediates involved in biosynthesis of Capsaicin and its analogues in Capsicum fruits. Agri. Biol. Chem.46: 2685), determination of enzymatic activities (Ochoa-Alejo and Gomez-Peralta, J. E. 1993. Activity of enzymes involved in Capsaicin biosynthesis in callus tissue and fruits of Chilli pepper (Capsicum annuum L.). J. Plant Physiol. 141: 147) and abundance of intermediates as a function of fruit development (Curry, J., Maneesha Aluru, Marcus Mendoza, Jacob Nevarez, Martin Melendez and Mary A O'Connell. 1999. Transcripts of possible Capsaicnoid biosynthetic genes are differentially accumulated in pungent and non-pungent Capsicum spp. Plant Sci., 148: 47)

In the Phenyl Proponoid Pathway leading to Capsaicin biosynthesis, Phenyl-alanine Ammonia Lyase (PAL) is the enzyme which catalyses the first step in the pathway using L-Phenylalanine as substrate and rendering Cinnamic acid which is subsequently converted to p-Coumaric acid, Caffeic Acid, Ferulic Acid by the action of Cinnamic acid-4-Hydroxylase (Ca4H), p-Coumaric Acid-3-hydroxylase (Ca3H) and Caffeic acid-O-methyltransferase (CoMT) (Fujiwake, H., Suzuki, T., Oka, S and Iwai. 1980. Enzymatic formation of Capsaicinoids from Vanillylamine and Iso-type fatty acids by cell free extracts of C. annuum var annuum cv. Karayatsunbusa. Agri. Biol. Chem.44: 2907).

The enzyme that participates in the transformation of Ferulic Acid to vanillin is unknown (Ochoa-Alejo and Gomez-Peralta, J. E. 1993. Activity of enzymes involved in Capsaicin biosynthesis in callus tissue and fruits of Chilli pepper (Capsicum annuum L.). J. Plant Physiol. 141: 147).

The putative aminotransferase (Pamt) is responsible for conversion of vanillin to Vanillylarnine (Curry, J., Maneesha Aluru, Marcus Mendoza, Jacob Nevarez, Martin Melendez and Mary A O'Connell. 1999. Transcripts of possible Capsaicnoid biosynthetic genes are differentially accumulated in pungent and non-pungent Capsicum spp. Plant Sci., 148: 47).

Finally, the enzymatic condensation of Vanillylamine and 8-methyl-6-nonenoyl CoA to yield Capsaicin is presumed to be brought about by Capsaicin synthase (CS). Based on the sequence and expression analysis, SB2-66 clone is presumed to be CS (Kim, M., Shinje Kim, Soohyun Kim and Byung-Dong Kim. 2001. Isolation of cDNA clones differentially accumulated in the placenta of pungent peppers by Suppression Subtractive Hybridization. Mol. Cells. 11(2): 213).

From available literature and to our knowledge there are no reports on the enhancement of phenyl propanoid intermediates and capsaicinoids in C. frutescens under field conditions through elicitors. The present study aimed at enhancement of the pungency constituents of Capsicum fruits under the influence of certain biotic and abiotic microbial elicitors under field conditions.

Although Capsaicinoids and other pungency causing compounds produced naturally in fruits of Capsicum, a new and useful spray formulation that provides an enhanced pungency in fruits of Capsicum is most desirable. Accordingly, it is an object of the present invention to provide a process for preparation of a pungency enhancing spray useful for Capsicum.

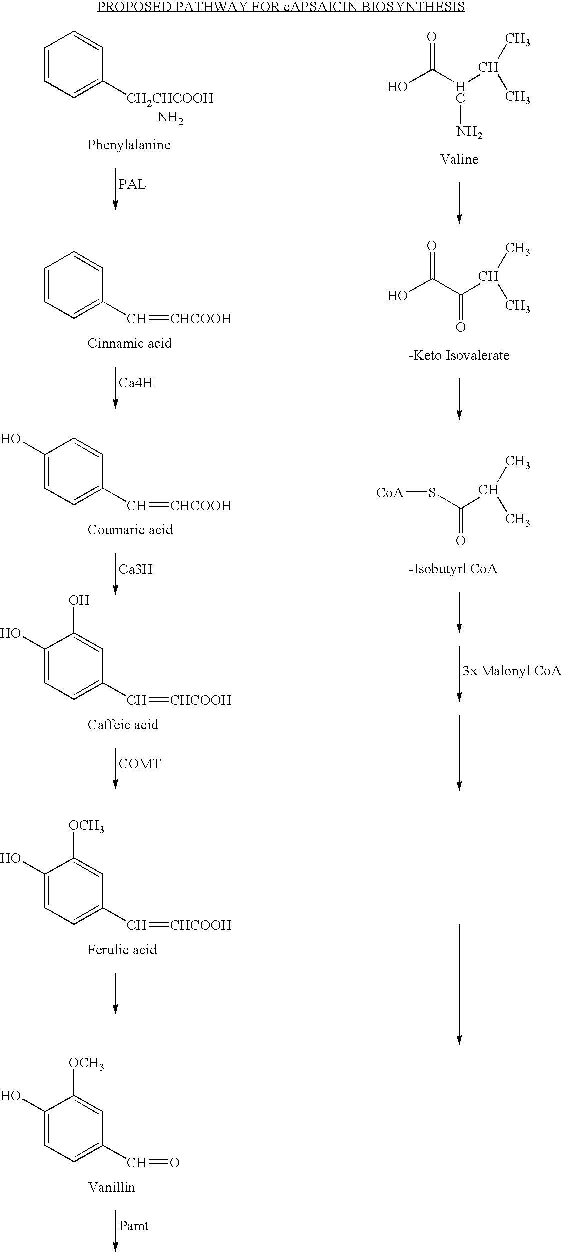

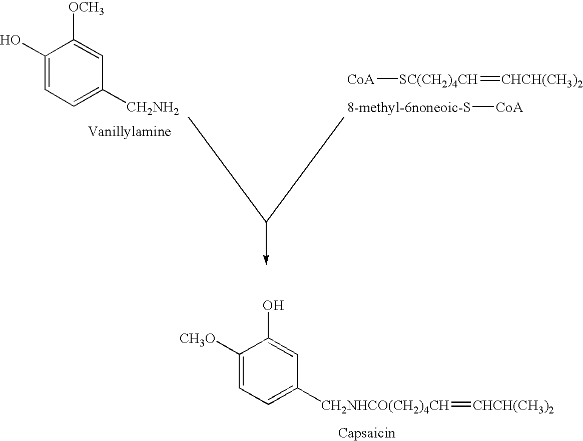

### OBJECT OF THE PRESENT INVENTION

It is a further object of the present invention to provide a spray formulation, which is effective as an elicitor.

It is a further object of the invention to provide a new spray formulation, which is effective as an enhancer of pungency of Capsicum fruits.

### SUMMARY OF THE INVENTION

In accordance with the objects of this invention, there is provided herein the spray formulation, which is very efficient for capsaicinoids enhancements. The spray formulation provide an extremely spicy, pungency improvements in chili fruits at field level that considerably more than untreated controls, and has greater intensity concentration than controls thereof. The spray formulation further provides elicitor properties.

### DETAILED DESCRIPTIION OF PREFERRED EMBODIMENTS

The spray formulation that is prepared for enhancement of the phenyl propanoid intermediates and capsaicinoids, which are the pungency causing factors of Chilli fruit, was mainly in liquid form. The main component of this formulation is water with diluted mycelial extracts of the selected fungi. The mycelial extracts of the said fungi and also some abiotic elicitors were used in formulation after autoclaving, hence considered as safe for preservation at low temperature. As the elicitor formulation is mainly in liquid form the same can be used as spray at specified concentration to flowers of Capsicum plants for improvement of pungency constituents in harvested fruits.

According to the present invention, a process for preparation of pungency enhancing spray useful for Capsicum involves different steps. Initially it involves the Establishment of C. frutescens (collected wild from BR Hills, Karnataka) seedlings, their subsequent transplantation and cultivation under field conditions.

The present invention is directed to determination of phenyl propanoid intermediates and Capsaicinoids in the C. frutescens fruits of different age (25, 30, 35 and 40 days post anthesis) by tagging the flowers on the day of anthesis.

The present invention is also directed to spraying of fungal mycelial extracts (concentration 0.25, 0.5, 1.0 and 2.0% w/v) of Aspergillus niger, Aspergillus parasiticus and Rhizopus oligosporus and abiotic elicitor Methyl Jasmonate and Salicylic Acid (in the range of 1.0, 2.5 and 5.0 mM) to the fully opened flowers, branches containing flowers and whole plant bearing flowers to determine the dosage of elicitors and appropriate stage of effective action. This is followed by determination and elucidation of enhanced levels of phenyl propanoid intermediates and Capsaicinoids in elicited treated post anthesis harvested fruits of C. frutescens by known methods.

In embodiments a process for enhancement of phenyl propanoid intermediates and capsaicinoids in C. frutescens in field grown plants was developed by spraying biotic and abiotic elicitors. The stage of harvest, type of elicitors and optimum dosage was determined.

In other embodiments, the elicitor treated plant fruits were harvested and later analyzed for enhanced phenyl propanoid intermediates and capsaicinoids by known methods using HPLC.

The novelty of the present invention is, it provides for the first time an efficient spray formulation of microbial and abiotic elicitors for enhancement of pungency of C. frutescens under field conditions. Elicitation of phenyl propanoid intermediates and pungency levels in C. frutescens by microbial cultures is achieved at field level, which is highly practicable compared to the in vitro cultures. High pungent Capsicum is one of the pre requisites for Capsicum oleoresin production. Hence this process can surmount this problem and can provide high quality material for Capsicum oleoresin industry.

Examples of formulations are also given. These examples are not meant to limit the disclosure. Other methods of formation and formulations may be used as would be known to one of ordinary skill in the art.

### EXAMPLES

The following examples are given by way of illustration of the present invention and should not be considered to limit the scope of the present invention.

### Example 1

The seedlings of Capsicum frutescens Mill were raised in soil bed. The seeds of C. frutescens were collected from BR. Hills, Karnataka, INDIA. The 2 months old seedling plants were transplanted to the soil and grown under controlled conditions to avoid cross-pollination after the onset of flowering. The plants were established well two months after transplantation and started to flower by 90 days with proper agronomic practices with regard to irrigation, fertilizer application, weeding and proper care from major pests and diseases.

The fungal stock cultures Aspergillus niger, Aspergillus parasiticus, Rhizopus oligosporus were used for this study. Fresh culture were made on PDA slants and incubated for 7 days. Then the spores of the respective fungi were used to prepare spore suspension or inoculum in 0.1% sodium lauryl sulphate and diluted ultimately to get a spore density of ˜2.5×10⁶ spore/ml). Later the same was inoculated into the 50 ml of PDA broth contained in 250 ml Erlenmeyer conical flasks (10 replicates) and the cultures were incubated in dark for 10 days. After incubation the cultures were autoclaved and later the mycelium was separated from the culture broth by filtration and its fresh weight and also the dry weight was recorded. The fungus was grown in a 250 ml conical flask containing 50 ml of PDA and inoculated at room temperature. At the stationary phase the flask with cultures were autoclaved and fungal mycelial mat was separated by filtration. The mycelial mat was washed several times with distilled water and an aqueous extract was made by homogenizing in mortar and pistle-using acid washed with neutralized sand. The extract was filtered through a nylon membrane. The mycelial extracts were sterilized by autoclaving before use. The fungal mycelial extracts at a concentration of 0.25, 0.5, 1.0 and 2.0% w/v were sprayed to the fully opened flowers, whole plants bearing flowers, and branches containing flowers.

The flowers of C. frutescens were sprayed with water, which was taken as control. The fruits of C. frutescens which received different treatments were harvested on 25, 30, 35 and 40 days after anthesis and extracted with 1:2 (w/v) of acetonitrile followed by in-vacuo evaporation and resuspension with 1 ml methanol. The extracted samples were centrifuged at 4000 rpm for 10 minutes. The samples were subjected to High Performance Liquid Chromatography for quantification of phenyl proponoid intermediates and major Capsaicinoids. The mobile phase of linear gradient of 0-100 % acetonitrile in water with pH 3.0 for 35 minutes and 100% was maintained for 2 minutes at 35^{th} minute. The detection was at 236 nm and flow rate was maintained at 1 ml/min. C-18 column of 250×4.6 mm and 5-μm diameter was used. The reagent used was of HPLC grade. The intermediates of phenyl proponoid pathway (Phenylalanine, Cinnamic acid, Coumaric acid, Caffeic acid, Ferulic acid and Vanillylamine) and two major Capsaicinoids (Capsaicin and Dihydrdcapsaicin) were purchased from Sigma Co. A standard stock solution of 1 mg/ml was prepared in methanol. 5 and 10 μl of standards and samples was injected to HPLC for three times and the mean value was calculated. Standard deviation of samples was calculated according to Tukey's method.

Effect of Rhizopus oligosporus on levels of Phenyl Propanoid Pathway intermediates and Capsaicinoids

| | | | Cinnamic | Coumaric | Caffeic | Ferulic | | | Dihydro |
|---|---|---|---|---|---|---|---|---|---|
| | Concentration | Phenylalanine | Acid | Acid | Acid | Acid | Vanillylamine | Capsaicin | capsaicin |
| Days | (% W/v) | (μM) | (μM) | (μM) | (μM) | (μM) | (μM) | (μM) | ((μM) |
| 25 | Control | 375 ± 8 | 9 ± 0.8 | 19 ± 1.2 | 3 ± 0.8 | 30 ± 2.5 | 47 ± 4.1 | 15 ± 0.9 | 5 ± 0.8 |
| | 0.25 | 393 ± 8.2 | 10 ± 1 | 47 ± 3.1 | 5 ± 0.9 | 44 ± 3.4 | 119 ± 9.8 | 29 ± 1.5 | 10 ± 0.9 |
| | 0.50 | 434 ± 7.5 | 10 ± 1 | 49 ± 3.3 | 8 ± 1.0 | 51 ± 4.2 | 125 ± 11.2 | 31 ± 2.5 | 12 ± 1.0 |
| | 1.00 | 499 ± 5.5 | 16 ± 1.2 | 55 ± 4.0 | 10 ± 1.2 | 55 ± 4.1 | 138 ± 12.3 | 82 ± 6.5 | 15 ± 1.4 |
| | 2.00 | 377 ± 6.2 | 9 ± 0.8 | 21 ± 1.5 | 3 ± 0.4 | 32 ± 2.8 | 49 ± 4.1 | 18 ± 1.4 | 8 ± 0.7 |
| 30 | Control | 504 ± 6.5 | 11 ± 1.0 | 23 ± 1.7 | 4 ± 0.3 | 36 ± 3.1 | 59 ± 4.8 | 30 ± 2.4 | 10 ± 0.9 |
| | 0.25 | 530 ± 8.0 | 16 ± 1.3 | 54 ± 4.1 | 6 ± 0.7 | 56 ± 3.5 | 135 ± 12.1 | 51 ± 4.2 | 20 ± 1.4 |
| | 0.50 | 544 ± 6.2 | 20 ± 1.8 | 53 ± 4.0 | 9 ± 0.7 | 67 ± 5.4 | 141 ± 13.4 | 52 ± 4.1 | 25 ± 2.4 |
| | 1.00 | 566 ± 5.8 | 20 ± 1.5 | 73 ± 5.0 | 11 ± 1.2 | 91 ± 8.7 | 144 ± 12.4 | 181 ± 15.1 | 33 ± 2.9 |
| | 2.00 | 504 ± 7.4 | 12 ± 1.0 | 30 ± 2.1 | 4 ± 0.5 | 41 ± 5.6 | 62 ± 5.6 | 36 ± 2.8 | 19 ± 1.4 |
| 35 | Control | 774 ± 5.8 | 18 ± 1.4 | 24 ± 2.0 | 10 ± 1.0 | 62 ± 5.0 | 61 ± 6.0 | 31 ± 3.0 | 14 ± 1.2 |
| | 0.25 | 818 ± 8.7 | 31 ± 2 | 57 ± 3.8 | 18 ± 1.5 | 106 ± 8.1 | 144 ± 13.5 | 80 ± 7.4 | 28 ± 2.1 |
| | 0.50 | 863 ± 5.7 | 40 ± 3.2 | 60 ± 5.0 | 23 ± 1.8 | 139 ± 10. [symbol] | 152 ± 14.2 | 115 ± 12.4 | 35 ± 3.1 |
| | 1.00 | 924 ± 7.5 | 44 ± 3 | 98 ± 7.0 | 36 ± 2.6 | 294 ± 15. [symbol] | 246 ± 20.1 | 327 ± 24.5 | 56 ± 4.5 |
| | 2.00 | 592 ± 6.4 | 20 ± 1.4 | 30 ± 2.5 | 10 ± 1.0 | 67 ± 5.4 | 65 ± 6.2 | 37 ± 5.5 | 27 ± 1.8 |
| 40 | Control | 539 ± 8.2 | 15 ± 1.3 | 22 ± 2.4 | 10 ± 1.2 | 64 ± 6.4 | 56 ± 6.2 | 27 ± 2.1 | 12 ± 0.8 |
| | 0.25 | 544 ± 5.6 | 26 ± 2.0 | 46 ± 3.5 | 16 ± 1.4 | 111 ± 9.8 | 120 ± 12.0 | 70 ± 6.5 | 20 ± 1.5 |
| | 0.50 | 566 ± 6.5 | 29 ± 1.3 | 48 ± 3.4 | 21 ± 2.0 | 145 ± 13 | 118 ± 10.1 | 73 ± 7.1 | 28 ± 2.4 |
| | 1.00 | 584 ± 5.4 | 38 ± 2.0 | 67 ± 5.2 | 33 ± 2.8 | 168 ± 14 | 168 ± 12.4 | 277 ± 21.5 | 44 ± 3.4 |
| | 2.00 | 512 ± 5.8 | 16 ± 1.4 | 28 ± 1.8 | 12 ± 1.0 | 67 ± 5.8 | 60 ± 5.6 | 32 ± 3.2 | 15 ± 1.2 |

Number of samples: 4 per replication
Number of replication: 3
Maximum Elicitation of phenyl propanoid intermediates and Capsaicin (327 μM) was observed at 35 days after anthesis when R. oligosporus was sprayed at the concentration of 1% w/v to the flowers of C. frutescens

Effect of Aspergillus niger on levels of Phenyl Propanoid Pathway intermediates and capsaicinoids

| | | | Cinnamic | Coumaric | Caffeic | Ferulic | | | |
|---|---|---|---|---|---|---|---|---|---|
| | Concentration | Phenylalanine | Acid | Acid | Acid | Acid | Vanillylamine | Capsaicin | Dihydrocapsaicin |
| Days | (% W/v) | (μM) | (μM) | (μM) | (μM) | (μM) | (μM) | (μM) | ((μM) |
| 25 | Control | 375 ± 8 | 9 ± 0.8 | 19 ± 1.2 | 3 ± 0.8 | 30 ± 2.5 | 47 ± 4.1 | 15 ± 0.9 | 5 ± 0.8 |
| | 0.25 | 383 ± 7.5 | 9.2 ± 0.9 | 22 ± 2.0 | 3.5 ± 0.7 | 33 ± 2.8 | 50 ± 5.2 | 19 ± 1.2 | 7 ± 0.8 |
| | 0.50 | 394 ± 5.8 | 9.6 ± 0.8 | 24 ± 1.9 | 3.8 ± 0.9 | 35 ± 2.7 | 52 ± 4.8 | 21 ± 1.1 | 7.2 ± 0.9 |
| | 1.00 | 399 ± 6.2 | 10.8 ± 1.0 | 29 ± 2.4 | 4.2 ± 0.7 | 37 ± 3.1 | 58 ± 6.2 | 24 ± 1.8 | 8.9 ± 0.8 |
| | 2.00 | 376 ± 5.8 | 9.8 ± 0.9 | 23 ± 1.8 | 3.9 ± 0.8 | 32 ± 3.9 | 54 ± 5.1 | 17 ± 1.1 | 8 ± 0.9 |
| 30 | Control | 504 ± 6.5 | 11 ± 1.0 | 23 ± 1.7 | 4 ± 0.3 | 36 ± 3.1 | 59 ± 4.8 | 30 ± 2.4 | 10 ± 0.9 |
| | 0.25 | 516 ± 9.1 | 11.8 ± 1.2 | 24 ± 3.2 | 4.5 ± 0.8 | 38 ± 2.9 | 62 ± 11.0 | 32 ± 2.9. | 11.8 ± 1.2 |
| | 0.50 | 524 ± 8.2 | 12.4 ± 1.4 | 26 ± 2.8 | 5.2 ± 0.8 | 40 ± 3.4 | 71 ± 11.2 | 37 ± 3.4 | 12.8 ± 1.4 |
| | 1.00 | 528 ± 9.8 | 13.5 ± 1.2 | 30 ± 2.9 | 5.8 ± 0.7 | 42 ± 2.8 | 84 ± 8.9 | 41 ± 3.7 | 14.2 ± 1.2 |
| | 2.00 | 521 ± 8.4 | 12.8 ± 1.1 | 29 ± 2.0 | 5.2 ± 0.8 | 42 ± 3.7 | 62 ± 5.7 | 36 ± 3.4 | 12.0 ± 1.6 |
| 35 | Control | 774 ± 5.8 | 18 ± 1.4 | 24 ± 2.0 | 10 ± 1.0 | 62 ± 5.0 | 61 ± 6.0 | 31 ± 3.0 | 14 ± 1.2 |
| | 0.25 | 784 ± 7.8 | 21 ± 1.8 | 27 ± 3.4 | 11 ± 0.9 | 64 ± 4.7 | 64 ± 5.9 | 35 ± 3.1 | 18.2 ± 1.8 |
| | 0.50 | 789 ± 7.8 | 24 ± 2.4 | 30 ± 2.8 | 12 ± 1.0 | 68 ± 5.2 | 68 ± 8.2 | 42 ± 3.4 | 21 ± 1.9 |
| | 1.00 | 799 ± 7.9 | 26 ± 2.8 | 34 ± 2.8 | 15 ± 1.6 | 75 ± 4.72 | 96 ± 7.1 | 49 ± 4.5 | 26 ± 1.4 |
| | 2.00 | 792 ± 8.4 | 20 ± 2.7 | 30 ± 3.1 | 13 ± 1.2 | 67 ± 6.2 | 65 ± 5.8 | 39 ± 4.8 | 22 ± 1.8 |
| 40 | Control | 539 ± 8.2 | 15 ± 1.3 | 22 ± 2.4 | 10 ± 1.2 | 64 ± 6.4 | 56 ± 6.2 | 27 ± 2.1 | 12 ± 0.8 |
| | 0.25 | 540 ± 8.2 | 23 ± 1.9 | 24 ± 3.0 | 12 ± 1.0 | 65 ± 5.7 | 60 ± 8.4 | 32 ± 3.2 | 14 ± 1.2 |
| | 0.50 | 552 ± 5.8 | 26 ± 1.5 | 28 ± 2.9 | 15 ± 1.1 | 68 ± 6.1 | 68 ± 6.8 | 34 ± 3.8 | 18 ± 1.4 |
| | 1.00 | 560 ± 9.5 | 29 ± 2.8 | 32 ± 4.5 | 14 ± 1.5 | 72 ± 8.2 | 88 ± 8.3 | 39 ± 3.7 | 24 ± 2.1 |
| | 2.00 | 545 ± 8.4 | 26 ± 1.8 | 29 ± 2.8 | 12 ± 1.1 | 67 ± 5.7 | 60 ± 6.5 | 39 ± 3.6 | 21 ± 1.4 |

Number of samples: 4 per replication
Number of replication: 3
Maximum Elicitation of phenyl propanoid intermediates and Capsaicin (49 μM) was observed at 35 days after anthesis when A. niger was sprayed at the concentration of 1% w/v to the flowers of C. frutescens

Effect of Aspergillus parasiticus on levels of Phenyl Propanoid Pathway intermediates and Capsaicinoids

| | | | Cinnamic | Coumaric | Caffeic | Ferulic | | | |
|---|---|---|---|---|---|---|---|---|---|
| | Concentration | Phenylalanine | Acid | Acid | Acid | Acid | Vanillylamine | Capsaicin | Dihydrocapsaicin |
| Days | (% W/v) | (μM) | (μM) | (μM) | (μM) | (μM) | (μM) | (μM) | ((μM) |
| 25 | Control | 375 ± 8 | 9 ± 0.8 | 19 ± 1.2 | 3 ± 0.8 | 30 ± 2.5 | 47 ± 4.1 | 15 ± 0.9 | 5 ± 0.8 |
| | 0.25 | 396 ± 8.9 | 10 ± 1.0 | 24 ± 1.8 | 3.8 ± 0.8 | 38 ± 1.7 | 55 ± 4.5 | 21 ± 1.2 | 9 ± 0.7 |
| | 0.50 | 399 ± 6.5 | 11.0 ± 1.9 | 27 ± 1.5 | 3.9 ± 0.8 | 39 ± 1.8 | 59 ± 4.2 | 24 ± 2.1 | 12.2 ± 0.9 |
| | 1.00 | 402 ± 5.9 | 12.5 ± 1.0 | 29 ± 1.5 | 4.6 ± 0.7 | 42 ± 1.6 | 69 ± 4.8 | 29 ± 2.0 | 14.0 ± 0.9 |
| | 2.00 | 378 ± 9.8 | 10.9 ± 1.1 | 25 ± 1.4 | 4.1 ± 0.9 | 45 ± 2.1 | 64 ± 4.7 | 27 ± 1.8 | 13.5 ± 1.1 |
| 30 | Control | 504 ± 6.5 | 11 ± 1.0 | 23 ± 1.7 | 4 ± 0.3 | 36 ± 3.1 | 59 ± 4.8 | 30 ± 2.4 | 10 ± 0.9 |
| | 0.25 | 516 ± 8.4 | 12.5 ± 2.1 | 27 ± 2.2 | 4.6 ± 0.7 | 39 ± 2.4 | 64 ± 5.4 | 34 ± 2.5 | 12 ± 1.1 |
| | 0.50 | 527 ± 8.9 | 13.4 ± 1.4 | 29 ± 2.4 | 4.8 ± 0.6 | 40 ± 2.7 | 69 ± 6.7 | 39 ± 2.8 | 12.8 ± 1.3 |
| | 1.00 | 536 ± 7.8 | 15.2 ± 1.2 | 34 ± 2.4 | 5.8 ± 0.5 | 48 ± 2.9 | 82 ± 5.8 | 42 ± 3.4 | 16.2 ± 1.4 |
| | 2.00 | 531 ± 9.8 | 15.0 ± .0 | 29 ± 2.1 | 5.4 ± 0.9 | 45 ± 2.8 | 72 ± 5.9 | 39 ± 2.9 | 13.0 ± 1.5 |
| 35 | Control | 774 ± 5.8 | 18 ± 1.4 | 24 ± 2.0 | 10 ± 1.0 | 62 ± 5.0 | 61 ± 6.0 | 31 ± 3.0 | 14 ± 1.2 |
| | 0.25 | 795 ± 8.7 | 24 ± 1.4 | 27 ± 2.1 | 12 ± 1.0 | 65 ± 2.7 | 66 ± 6.2 | 42 ± 3.4 | 15 ± 1.9 |
| | 0.50 | 797 ± 8.9 | 26 ± 1.4 | 30 ± 2.4 | 12.8 ± 1 | 69 ± 2.9 | 69 ± 5.8 | 49 ± 3.9 | 18 ± 2.1 |
| | 1.00 | 825 ± 7.8 | 29 ± 2.4 | 38 ± 3.1 | 18 ± 1.6 | 78 ± 4.2 | 89 ± 6.8 | 102 ± 3.9 | 28.6 ± 2.1 |
| | 2.00 | 798 ± 6.9 | 25 ± 2.2 | 35 ± 2.1 | 14 ± 1.1 | 75 ± 6.2 | 69 ± 5.9 | 89 ± 4.4 | 24.6 ± 2.0 |
| 40 | Control | 539 ± 8.2 | 15 ± 1.3 | 22 ± 2.4 | 10 ± 1.2 | 64 ± 6.4 | 56 ± 6.2 | 27 ± 2.1 | 12 ± 0.8 |
| | 0.25 | 545 ± 8.6 | 19 ± 1.2 | 25 ± 3.0 | 12 ± 1.4 | 68 ± 3.5 | 65 ± 8.1 | 39 ± 3.4 | 14.6 ± 1.1 |
| | 0.50 | 589 ± 6.9 | 22 ± 1.4 | 27 ± 1.5 | 12.5 ± 1 | 69 ± 4.8 | 68 ± 5.9 | 49 ± 3.8 | 15.3 ± 1.2 |
| | 1.00 | 598 ± 5.9 | 27 ± 2.4 | 34 ± 2.8 | 16 ± 1.8 | 75 ± 5.2 | 78 ± 8.9 | 90 ± 3.4 | 21.2 ± 2.5 |
| | 2.00 | 588 ± 8.7 | 26 ± 2.1 | 30 ± 2.1 | 14 ± 1.7 | 74 ± 4.8 | 60 ± 6.7 | 88 ± 3.9 | 20.1 ± 2.1 |

Number of samples: 4 per replication
Number of replication: 3
Maximum Elicitation of phenyl Propanoid intermediates and Capsaicin (102 μM) was observed at 35 days after anthesis when A. parasiticus was sprayed at the concentration of 1% w/v to the flowers of C. frutescens

### Example 2

The seedlings of Capsicum frutescens Mill were raised in soil bed. The seeds of C. frutescens were collected from wild from BR Hills, Karnataka, INDIA. The 2 months old seedling plants were transplanted to the soil and grown under controlled conditions to avoid cross-pollination after the onset of flowering. The plants were established well 2 months after transplantation and started to flower by 90 days with proper agronomic practices with regard to irrigation, fertilizer application, weeding and care from major pests and diseases.

The abiotic elicitor (Methyl Jasmonate) was purchased from Duchefa Pvt.LTD. Methyl Jasmonate stock solution was prepared and later used at different concentrations (1 mM, 2.5 mM and 5 mM) for spraying to the whole plant containing flowers, completely opened flowers, and braches containing flowers. The flowers of C. frutescens were sprayed with water, which was taken as control. The fruits of C. frutescens which received different treatments were harvested on 25, 30, 35 and 40 days after anthesis and extracted with 1:2 (w/v) of acetonitrile followed by in-vacuo evaporation and resuspension with 1 ml methanol. The extracted samples were centrifuged at 4000 rpm for 10 minutes. The samples were subjected to High Performance Liquid Chromatography for quantification of phenyl proponoid intermediates and major Capsaicinoids. The mobile phase of linear gradient of 0-100% acetonitrile in water with pH 3.0 for 35 minutes and 100% was maintained for 2 minutes at 35 minute. The detection was at 236 nm and flow rate was maintained at 1 ml/min. C-18 column of 250×4.6 mm and 5-μm diameter was used. The reagent used was of HPLC grade. The intermediates of phenyl proponoid pathway (Phenylalanine, Cinnamic acid, Coumaric acid, Caffeic acid, Ferulic acid and Vanillylamine) and two major Capsaicinoids (Capsaicin and Dihydrocapsaicin) were purchased from Sigma Co. A standard stock solution of 1 mg/ml was prepared in methanol. 5 and 10 μl of standards and samples was injected to HPLC for three times and the mean value was calculated. Standard deviation of samples was calculated according to Tukey's method.

Effect of Methyl Jasmonate on elicitation of phenyl propanoid intermediates leading to Capsaicin Biosynthesis

| | | | Cinnamic | Coumaric | Caffeic | Ferulic | | | |
|---|---|---|---|---|---|---|---|---|---|
| | Conc. | Phenylalanine | Acid | Acid | Acid | Acid | Vanillylamine | Capsaicin | Dihydrocapsaicin |
| Days | (mM) | (μM) | (μM) | (μM) | (μM) | (μM) | (μM) | (μM) | (μM) |
| 25 | Control | 375 ± 8.0 | 3 ± 0.8 | 9 ± 0.8 | 19 ± 1.2 | 30 ± 2.5 | 47 ± 4.1 | 15 ± 0.9 | 5 ± 0.8 |
| | 1 | 388 ± 8.2 | 10 ± 1.0 | 44 ± 3.2 | 3 ± 0.9 | 33 ± 1.9 | 49 ± 3.4 | 17 ± 1.8 | 5 ± 0.8 |
| | 2.5 | 424 ± 9.2 | 11 ± 0.8 | 45 ± 3.8 | 3 ± 0.8 | 49 ± 2.5 | 63 ± 4.5 | 18 ± 1.2 | 6 ± 0.5 |
| | 5 | 391 ± 10.0 | 9 ± 0.8 | 42 ± 3.9 | 3 ± 0.6 | 48 ± 3.4 | 42 ± 2.9 | 16 ± 1.4 | 7 ± 0.8 |
| 30 | Control | 504 ± 8.5 | 4 ± 0.3 | 11 ± 1.0 | 23 ± 1.7 | 36 ± 3.1 | 59 ± 4.8 | 30 ± 2.4 | 10 ± 0.9 |
| | 1 | 563 ± 12.2 | 12 ± 0.9 | 38 ± 3.4 | 4 ± 1.1 | 68 ± 5.4 | 61 ± 5.4 | 41 ± 3.5 | 13 ± 1.0 |
| | 2.5 | 649 ± 8.7 | 35 ± 2.1 | 47 ± 4.2 | 12 ± 1.2 | 80 ± 4.5 | 96 ± 6.9 | 48 ± 3.6 | 14 ± 0.9 |
| | 5 | 627 ± 7.4 | 27 ± 1.8 | 45 ± 3.8 | 10 ± 0.9 | 73 ± 4.5 | 58 ± 5.1 | 48 ± 6.8 | 13 ± 0.7 |
| 35 | Control | 774 ± 5.8 | 10 ± 1.0 | 18 ± 1.4 | 24 ± 2.0 | 62 ± 5 | 61 ± 6.0 | 31 ± 3.0 | 14 ± 1.2 |
| | 1 | 879 ± 5.9 | 23 ± 1.5 | 44 ± 4.2 | 12 ± 1.2 | 122 ± 8 | 111 ± 10.8 | 36 ± 3.8 | 15 ± 1.2 |
| | 2.5 | 1052 ± 11 | 68 ± 4.5 | 84 ± 4.1 | 37 ± 3.2 | 150 ± 8 | 107 ± 10.2 | 51 ± 4.1 | 19 ± 1.3 |
| | 5 | 921 ± 8.9 | 36 ± 3.2 | 59 ± 3.8 | 20 ± 1.2 | 121 ± 12 | 73 ± 7.1 | 35 ± 2.9 | 12 ± 1.0 |
| 40 | Control | 539 ± 8.2 | 10 ± 1.2 | 15 ± 1.3 | 22 ± 2.4 | 64 ± 6.4 | 56 ± 6.2 | 27 ± 2.1 | 12 ± 0.8 |
| | 1 | 516 ± 8.4 | 14 ± 1.2 | 39 ± 1.9 | 9 ± 0.8 | 107 ± 11 | 78 ± 6.8 | 33 ± 2.4 | 15 ± 1.2 |
| | 2.5 | 584 ± 9.2 | 23 ± 1.9 | 73 ± 2.4 | 15 ± 1.2 | 114 ± 12 | 98 ± 5.8 | 42 ± 3.2 | 18 ± 1.4 |
| | 5 | 547 ± 7.4 | 20 ± 1.5 | 44 ± 4.1 | 13 ± 1.3 | 67 ± 4.5 | 61 ± 5.1 | 28 ± 3.8 | 11 ± 1.3 |

Number of samples: 4 per replication
Number of replication: 3
Maximum elicitation of phenyl propanoid intermediates and Capsaicin (51 μM) was observed at 35 days after anthesis when Methyl Jasmonate was sprayed at the concentration of 2.5 mM to the flowers of C. frutescens.

### Example 3

The seedlings of Capsicum frutescens Mill were raised in soil bed. The seeds of C. frutescens were collected from BR. Hills, Karnataka. The 2 months old seedling plants were transplanted to the soil and grown under controlled conditions to avoid cross-pollination after the onset of flowering. The plants were established well two months after transplantation and started to flower by 90 days with proper agronomic practices with regard to irrigation, fertilizer application, weeding and care from major pests and diseases.

The abiotic elicitor (Salicylic acid sodium salt,) was purchased from Sigma, Co. USA. Salicylic acid stock solution was prepared and later used at different concentrations (1 mM, 2.5 mM and 5 mM) for spraying to the whole plant containing flowers, completely opened flowers, and braches containing flowers. The flowers of C. frutescens were sprayed with water, which was taken as control. The fruits of C. frutescens which received different treatments were harvested on 25, 30, 35 and 40 days after anthesis and extracted with 1:2 (w/v) of acetonitrile followed by in-vacuo evaporation and resuspension with 1 ml methanol. The extracted samples were centrifuged at 4000 rpm for 10 minutes. The samples were subjected to High Performance Liquid Chromatography for quantification of phenyl proponoid intermediates and major Capsaicinoids. The mobile phase of linear gradient of 0-100% acetonitrile in water with pH 3.0 for 35 minutes and 100% was maintained for 2 minutes at 35 minute. The detection was at 236nm and flow rate was maintained at 1 ml/min. C-18 column of 250×4.6 mm and 5-μm diameter was used. The reagent used was of HPLC grade. The intermediates of phenyl propanoid pathway (Phenylalanine, Cinnamic acid, Coumaric acid, Caffeic acid, Ferulic acid and Vanillylamine) and two major Capsaicinoids (Capsaicin and Dihydrocapsaicin) were purchased from Sigma Co. A standard stock solution of 1 mg/ml was prepared in methanol. 5 and 10 μl of standards and samples was injected to HPLC for three times and the mean value was calculated. Standard deviation of samples was calculated according to Tukey's method.

Effect of Salicylic Acid sodium salt on elicitation of phenyl propanoid intermediates leading to Capsaicin Biosynthesis

| | | | Cinnamic | Coumaric | Caffeic | Ferulic | | | |
|---|---|---|---|---|---|---|---|---|---|
| | Conc. | Phenylalanine | Acid | Acid | Acid | Acid | Vanillylamine | Capsaicin | Dihydrocapsaicin |
| Days | (mM) | (μM) | (μM) | (μM) | (μM) | (μM) | (μM) | (μM) | (μM) |
| 25 | Control | 375 ± 8.0 | 3 ± 0.8 | 9 ± 0.8 | 19 ± 1.2 | 30 ± 2.5 | 47 ± 4.1 | 15 ± 0.9 | 5 ± 0.8 |
| | 1 | 378 ± 8.2 | 3.4 ± 0.9 | 12.0 ± 1.2 | 21 ± 1.0 | 31 ± 1.2 | 48 ± 1.4 | 16 ± 08 | 5 ± 0.7 |
| | 2.5 | 389 ± 9.2 | 3.9 ± 0.7 | 15 ± 1.4 | 25 ± 1.1 | 32 ± 1.4 | 49 ± 1.8 | 17 ± 1.1 | 5.5 ± 0.6 |
| | 5 | 379 ± 10.0 | 3.5 ± 0.6 | 14 ± 1.2 | 28 ± 1.2 | 34 ± 1.9 | 47 ± 2.1 | 16 ± 1.1 | 6 ± 0.7 |
| 30 | Control | 504 ± 8.5 | 4 ± 0.3 | 11 ± 1.0 | 23 ± 1.7 | 36 ± 3.1 | 59 ± 4.8 | 30 ± 2.4 | 10 ± 0.9 |
| | 1 | 514 ± 12.2 | 4.1 ± 1.1 | 12 ± 1.1 | 28 ± 1.0 | 35 ± 4.1 | 60 ± 1.9 | 35 ± 2.4 | 11 ± 1.1 |
| | 2.5 | 519 ± 8.7 | 4.9 ± 1.5 | 18 ± 1.2 | 30 ± 1.5 | 35 ± 3.9 | 67 ± 2.1 | 44 ± 1.1 | 12 ± 0.1 |
| | 5 | 528 ± 7.4 | 4.5 ± 1.1 | 15 ± 1.2 | 32 ± 1.1 | 38 ± 3.4 | 65 ± 4.2 | 42 ± 2.8 | 10 ± 0.6 |
| 35 | Control | 774 ± 5.8 | 10 ± 1.0 | 18 ± 1.4 | 24 ± 2.0 | 62 ± 5 | 61 ± 6.0 | 31 ± 3.0 | 14 ± 1.2 |
| | 1 | 778 ± 5.9 | 18 ± 1.0 | 24 ± 1.2 | 29 ± 1.0 | 64 ± 5 | 68 ± 1.9 | 38 ± 2.8 | 15 ± 1.0 |
| | 2.5 | 789 ± 11 | 25 ± 1.1 | 30 ± 1.5 | 42 ± 1.1 | 69 ± 6.8 | 77 ± 2.8 | 39 ± 2.8 | 16 ± 1.0 |
| | 5 | 891 ± 8.9 | 24 ± 1.1 | 21 ± 1.1 | 32 ± 1.0 | 65 ± 4.5 | 73 ± 3.6 | 36 ± 2.1 | 15 ± 0.9 |
| 40 | Control | 531 ± 8.2 | 10 ± 1.2 | 15 ± 1.3 | 22 ± 2.4 | 64 ± 6.4 | 56 ± 6.2 | 27 ± 2.1 | 12 ± 0.8 |
| | 1 | 532 ± 8.4 | 15 ± 1.0 | 21 ± 1.1 | 29 ± 1.1 | 62 ± 5 | 64 ± 5.8 | 31 ± 2.1 | 14 ± 1.0 |
| | 2.5 | 549 ± 9.2 | 23 ± 1.1 | 29 ± 1.4 | 35 ± 1.0 | 65 ± 6 | 68 ± 4.8 | 34 ± 2.8 | 15 ± 1.0 |
| | 5 | 547 ± 7.4 | 20 ± 1.0 | 24 ± 1.5 | 34 ± 1.1 | 67 ± 6 | 65 ± 6.1 | 38 ± 3.4 | 14 ± 1.1 |

Maximum Elicitation of phenyl propanoid intermediates and Capsaicin (39 μM) was observed at 35 days after anthesis when Salicylic Acid was sprayed at the concentration of 2.5 mM to the flowers of C. frutescens
Number of samples: 4 per replication
Number of replication: 3

### Example 4

The seedlings of Capsicum annuum var Arka Lohit were raised in soil bed. The seeds of Capsicum annuum var Arka Lohit were received from Indian Institute of Horticultural Research, Bangalore, INDIA. The 2 months old seedling plants were transplanted to the soil and grown under controlled conditions to avoid cross-pollination after the onset of flowering. The plants were established well two months after transplantation and started to flower by 90 days with proper agronomic practices with regard to irrigation, fertilizer application, weeding and care from major pests and diseases.

The fungal stock cultures Aspergillus niger, Aspergillus parasiticus, Rhizopus oligosporus were used for this study. Fresh culture were made on PDA slants and incubated for 7 days. Then the spores of the respective fungi were used to prepare spore suspension or inoculum in 0.1% sodium lauryl sulphate and diluted ultimately to get a spore density of ˜2.5×10⁶ spore/ml). Later the same was inoculated into the 50 ml of PDA broth contained in 250 ml Erlenmeyer conical flasks (10 replicates) and the cultures were incubated in dark for 10 days. After incubation the cultures were autoclaved and later the mycelium was separated from the culture broth by filtration and its fresh weight and also the dry weight was recorded. The fungus was grown in a 250 ml conical flask containing 50 ml of PDA and inoculated at room temperature. At the stationary phase the flask with cultures were autoclaved and fungal mycelial mat was separated by filtration. The mycelial mat was washed several times with distilled water and an aqueous extract was made by homogenizing in mortar and pestle using acid washed with neutralized sand. The extract was filtered through a nylon membrane. The mycelial extracts were sterilized by autoclaving before use. Similarly the abiotic elicitor (Salicylic acid sodium salt and Methyl Jasmonate) was purchased from Sigma, Co. USA. Salicylic acid stock solution and Methyl Jasmonate was prepared. Biotic and abiotic elicitors were mixed with a concentration in the range of 0.25 to 2.0% w/v and 1 to 5 μM respectively and later used for spraying to the whole plant containing flowers, completely opened flowers, and braches containing flowers.

The flowers of C. annuum var Arka Lohit were sprayed with water, which was taken as control. The fruits of C. annuum var Arka Lohit which received different treatments were harvested on 25, 30, 35 and 40 days after anthesis and extracted with 1:2 (w/v) of Acetonitrile followed by in-vacuo evaporation and resuspension with 1 ml methanol. The extracted samples were centrifuged at 4000 rpm for 10 minutes. The samples were subjected to High Performance Liquid Chromatography for quantification of phenyl proponoid intermediates and major Capsaicinoids. The mobile phase of linear gradient of 0-100% acetonitrile in water with pH 3.0 for 35 minutes and 100% was maintained for 2 minutes at 35^{th} minute. The detection was at 236 nm and flow rate was maintained at 1 ml/min. C-18 column of 250×4.6 mm and 5-μm diameter was used. The reagent used was of HPLC grade. The intermediates of phenyl proponoid pathway (Phenylalanine, Cinnamic acid, Coumaric acid, Caffeic acid, Ferulic acid and Vanillylamine) and two major Capsaicinoids (Capsaicin and Dihydrocapsaicin) were purchased from Sigma Co. A standard stock solution of 1 mg/ml was prepared in methanol. 5 and 10 μl of standards and samples was injected to HPLC for three times and the mean value was calculated. Standard deviation of samples was calculated according to Tukey's method.

Combined effect of biotic (1%) and abiotic (2.5 μM) elicitors on phenyl propanoid pathway intermediates and
Capsaicinoids in Capsicum frutescens at optimum concentration at 35^{th} day after anthesis

| Elicitors & their | | | | | | | | | |
|---|---|---|---|---|---|---|---|---|---|
| concentrations | | | Cinnamic | Coumaric | Caffeic | Ferulic | | | |
| Biotic | Abiotic | Phenylaanine | Acid | Acid | Acid | Acid | Vanillylamine | Capsaicin | DihydroCapsaicin |
| (1% w/v) | (2.5 μM) | (μM) | (μM) | (μM) | (μM) | (μM) | (μM) | (μM) | (μM) |
| R. oligosporus | Methyl | 986 ± 5 | 49 ± 2 | 86 ± 2 | 36.8 ± 2 | 269 ± 2 | 245 ± 2 | 315 ± 7 | 54 ± 2 |
| | Jasmonate | | | | | | | | |
| R. oligosporus | Salicylic | 869 ± 6 | 43 ± 2 | 68 ± 2 | 38 ± 3 | 251 ± 2 | 241 ± 3 | 309 ± 6 | 54 ± 3 |
| | acid | | | | | | | | |
| A. niger | Methyl | 832 ± 5 | 35 ± 1 | 49 ± 3 | 26 ± 2 | 105 ± 3 | 98 ± 2 | 96 ± 3 | 26 ± 2 |
| | Jasmonate | | | | | | | | |
| A. niger | Salicylic | 824 ± 8 | 28 ± 3 | 35 ± 1 | 36 ± 1 | 79 ± 4 | 85 ± 2 | 101 ± 3 | 24 ± 2 |
| | acid | | | | | | | | |
| A. parasiticus | Methyl | 815 ± 8 | 36 ± 2 | 53 ± 3 | 29 ± 2 | 129 ± 3 | 105 ± 3 | 49 ± 3 | 24 ± 3 |
| | Jasmonate | | | | | | | | |
| A. parasiticus | Salicylic | 795 ± 6 | 25 ± 3 | 33 ± 2 | 35 ± 2 | 74 ± 2 | 89 ± 3 | 45 ± 2 | 27 ± 2 |
| | acid | | | | | | | | |

| | | | | | | | | |
|---|---|---|---|---|---|---|---|---|
| Control | 774 ± 5.8 | 10 ± 1.0 | 18 ± 1.4 | 24 ± 2.0 | 62 ± 5 | 61 ± 6.0 | 31 ± 3.0 | 14 ± 1.2 |

Maximum Elicitation of phenyl propanoid intermediates and Capsaicin (315 μM) was observed at 35 days after anthesis when Rhizopus oligosporus (1% w/v) and Methyl Jasmonate (2.5 μM) were to the flowers of C. frutescens Mill.
Number of samples: 4 per replication
Number of replication: 3

Combined effect of biotic (0.5%) and abiotic (2.5 μM) elicitors on phenyl propanoid
pathway intermediates and Capsaicinoids in Capsicum annuum at optimum
concentration at 35^{th} day after anthesis

| Elicitors and their | | | | | | | | | |
|---|---|---|---|---|---|---|---|---|---|
| concentrations | | | Cinnamic | Coumaric | Caffeic | Ferulic | | | |
| | Abiotic | Phenylalanine | Acid | Acid | Acid | Acid | Vanillylamine | Capsaicin | DihydroCapsaicin |
| Biotic (0.5% w/v) | (2.5 μM) | (μM) | (μM) | (μM) | (μM) | (μM) | (μM) | (μM) | (μM) |
| R. oligosporus | Methyl | 545 ± 6 | 23 ± 3 | 21 ± 2 | 10 ± 1 | 41 ± 2 | 29 ± 2 | 15 ± 2 | 3 ± 0.5 |
| | Jasmonate | | | | | | | | |
| R. oligosporus | Salicylic | 525 ± 4 | 23 ± 3 | 21 ± 2 | 9 ± 1 | 39 ± 2 | 30 ± 3 | 13 ± 2 | 2 ± 0.5 |
| | acid | | | | | | | | |
| A. niger | Methyl | 426 ± 6 | 22 ± 2 | 20 ± 2 | 8 ± 2 | 24 ± 2 | 21 ± 2 | 9 ± 2 | 3 ± 0.6 |
| | Jasmonate | | | | | | | | |
| A. niger | Salicylic | 431 ± 5 | 21 ± 3 | 20 ± 2 | 8 ± 1 | 23 ± 2 | 19 ± 1 | 9 ± 2 | 2.6 ± 0.2 |
| | acid | | | | | | | | |
| A. parasiticus | Methyl | 436 ± 6 | 22 ± 2 | 20 ± 3 | 9 ± 1 | 24 ± 3 | 18 ± 2 | 8 ± 1 | 3 ± 0.3 |
| | Jasmonate | | | | | | | | |
| A. parasiticus | Salicylic | 426 ± 5 | 23 ± 3 | 20 ± 3 | 8 ± 2 | 25 ± 2 | 19 ± 2 | 9 ± 1 | 3 ± 0.2 |
| | acid | | | | | | | | |

| | | | | | | | | |
|---|---|---|---|---|---|---|---|---|
| Control | 329 ± 1 | 16 ± 0.7 | 16 ± 1.4 | 5 ± 0.5 | 16 ± 2.4 | 12 ± 1.1 | 4.60 ± 1.4 | 1.80 ± 1.4 |

Maximum Elicitation of phenyl propanoid intermediates and Capsaicin (15 μM) was observed at 35 days after anthesis when Rhizopus oligosporus (0.5% w/v) and Methyl Jasmonate (2.5 μM) were to the flowers of C. annuum L.
Number of samples: 4 per replication
Number of replication: 3

Comparative effect of optimized concentration of abiotic and biotic (individually as well as in
combination) elicitors on number of folds enhancement of phenyl propanoid intermediates and
Capsaicinoids at 35 days after anthesis

| Elicitors and their | | Cinnamic | Coumaric | Caffeic | Ferulic | | | |
|---|---|---|---|---|---|---|---|---|
| concentrations | Phenylalanine | Acid | Acid | Acid | Acid | Vanillylamine | Capsaicin | Dihydrocapsaicin |
| R. oligosporus (0.5-1% w/v) | 1.19-1.69 | 1.36-2.44 | 1.35-4.08 | 1.96-3.6 | 2.48-4.74 | 1.24-2.54 | 3.25-10.55 | 1.54-4.01 |
| A. niger (0.5 to 1% w/v) | 1.03-1.18 | 1.24-1.44 | 1.29-1.42 | 1.36-1.50 | 1.21-1.39 | 1.45-1.57 | 1.58-2.63 | 1.69-1.86 |
| A. parasiticus (0.5-1% w/v) | 1.07-1.14 | 1.16-1.61 | 1.25-1.58 | 1.35-1.80 | 1.26-1.40 | 1.40-1.46 | 1.98-3.29 | 1.52-2.04 |
| Methyl Jasmonate (2.5 μM) | 1.36-1.52 | 1.42-3.79 | 1.25-3.51 | 1.63-3.79 | 1.59-2.43 | 1.68-1.77 | 1.65-1.88 | 1.41-1.68 |
| Salicylic acid (2.5 μM) | 1.02-1.44 | 1.36-2.50 | 1.28-1.67 | 1.45-1.75 | 1.11-1.28 | 1.26-1.28 | 1.26-1.58 | 1.11-1.32 |
| R. oligosporus (0.5-1% w/v) + | 1.27-1.66 | 1.44-2.72 | 1.31-3.58 | 2.00-3.68 | 2.56-4.34 | 2.42-4.02 | 3.26-10.16 | 1.67-3.86 |
| Methyl jasmonate (2.5 μM) | | | | | | | | |
| R. oligosporus (0.5-1% w/v) + | 1.12-1.60 | 1.44-2.39 | 1.31-2.83 | 1.80-3.80 | 2.444.05 | 2.50-3.95 | 2.83-9.97 | 1.11-3.86 |
| Salicylic acid (2.5 μM) | | | | | | | | |
| A. niger (0.5-1% w/v) + Methyl | 1.05-1.33 | 1.38-2.00 | 1.25-2.21 | 1.80-2.90 | 1.50-2.08 | 1.50-1.72 | 1.74-1.58 | 1.44-1.71 |
| Jasmonate (2.5 μM) | | | | | | | | |
| A. niger (0.5-1% w/v) + Salicylic | 1.03-1.29 | 1.44-1.39 | 1.25-1.38 | 1.60-3.50 | 1.19-1.56 | 1.46-1.58 | 1.45-1.96 | 1.63-1.93 |
| acid (2.5 μM) | | | | | | | | |
| A. parasiticus (0.5-1% w/v) + | 1.07-1.29 | 1.38-1.94 | 1.25-2.04 | 1.60-2.60 | 1.50-1.69 | 1.75-1.61 | 1.93-3.10 | 1.67-1.86 |
| Methyl Jasmonate (2.5 μM) | | | | | | | | |
| A. parasiticus (0.5-1% w/v) + | 1.06-1.31 | 1.31-1.56 | 1.25-1.46 | 1.60-3.60 | 1.27-1.44 | 1.39-1.58 | 1.96-3.26 | 1.39-1.71 |
| Salicylic acid (2.5 μM) | | | | | | | | |

Result:
At optimum concentrations of elicitors evaluated on Capsicum frutescens and Capsicum annuum, it was found that R. oligosporus (0.5 to 1% w/v) could enhance the Capsaicin and dihydrocapsaicin to the extent of 3.55 to 10 folds and 1.5 to 4 folds respectively and phenyl propanoid intermediates to the extent of 4.5 folds.

### REFERENCES

Curry, J., Maneesha Aluru, Marcus Mendoza, Jacob Nevarez, Martin Melendez and Mary A O'Connell. Transcripts of possible Capsaicnoid biosynthetic genes are differentially accumulated in pungent and non-pungent Capsicum spp. Plant Sci., 148: 47-57 (1999)

Dicosmo and Misawa. Elicitation of secondary metabolism in plant cultures Trend in Biotechnology 3: 318-320 (1985).

Fujiwake, H., Suzuki, T and Iwai. Intracellular distribution of enzymes and intermediates involved in biosynthesis of Capsaicin and its analogues in Capsicum fruits. Agri. Biol. Chem. 46: 2685-2688 (1982).

Fujiwake, H., Suzuki, T., Oka, S and Iwai. Enzymatic formation of Capsaicinoids from Vanillylamine and Iso-type fatty acids by cell free extracts of C. annuum var annuum cv. Karayatsunbusa. Agri. Biol. Chem. 44: 2907-2910 (1980).

Kaale, E., Ann Van Schepdael, Eugene Roets and Jos Hoogmartens. Determination of Capsaicinoids in topical cream by liquid-liquid extraction and liquid chromatography. J. Pharm Biomed Anal. 30: 1331-1337 (2002).

Kim, M., Shinje Kim, Soohyun Kim and Byung-Dong Kim. 2001. Isolation of cDNA clones differentially accumulated in the placenta of pungent peppers by Suppression Subtractive Hybridization. Mol. Cells. 11(2): 213-219 (2001).

Mathew, A. G., Lewis, J. S, Jagadishan, E. S, Nambudiri, E. S and Krishnamurhty, N. 1971. Oleoresin Capsicum. The flavor Industry. 2(1): 23-26 (1971).

Mathur, R., Dangi, R. S., Dass, S. C. and Malhotra, R. C. The hottest chilli variety in India. Curr. Sci. 79(3): 287-288 (2000).

Ochoa-Alejo and Gomez-Peralta, J. E. Activity of enzymes involved in Capsaicin biosynthesis in callus tissue and fruits of Chilli pepper (Capsicum annuum L.). J. Plant Physiol. 141: 147-153 (1993).

Sudhakar Johnson, T., Ravishankar G. A and Venkatraman L. V. 1993. Elicitation of capsaicin production in freely suspended cells and immobilized cell cultures of Capsicum frutescens Mill. Food Biotechnol. 5: 197-202 (1993).

Tewari, V. P. 1990. Development of high Capsaicin Chillies (Capsicum annuum L.) and their implications for the manufacture of export products. J. Plantation Crops. 18(1): 1-13 (1990)

1. A spray composition for enhancing pungency in fruits of Solanaceae family, said spray composition comprising (i) 2.5×10⁻¹ to 10×10⁻¹ (0.25-2% w/v) of a biotic elicitor selected from the group consisting of a fungal extract of Aspergillus niger, Aspergillus parasiticus, Rhizopus oligosporus and mixtures thereof; and (ii) 1×10⁻⁵ to 5×10⁻⁵M (1-5 μM) of abiotic elicitor selected from the consisting of Methyl Jasmonate and Salicylic Acidl in a suitable carrier.

2. The composition as claimed in claim 1, wherein the the fungal extract fungus is of Rhizopus oligosporus.

3. The composition as claimed in claim 1, wherein the fungal extract is a mycelial extract.

4. The composition of claim 1, wherein said carrier is water.

5. A method of enhancing pungency of fruits comprising spraying (i) 2.5×10⁻¹ to 10×10⁻¹ (0.25-2% w/v) of a biotic elicitor selected from the group consisting of a fungal extract of Aspergillus niger, Aspergillus parasiticus, Rhizopus oligosporus and mixtures thereof, and (ii) 1×10⁻⁵ to 5×10⁻⁵ M (1-5 μM) of abiotic elicitor selected from the group consisting of Methyl Jasmonate and Salicylic Acid, in a suitable carrier onto a plant with completely opened flowers, whereby the plant produces to fruits having enhanced pungency due to enhanced concentration of capsaicinoids of phenyl propanoid intermediates or a combination thereof in the fruits.

6. The method as claimed in claim 5, wherein the plant is a member of Solanaceae family.

7. A process of preparing the pungency enhancing composition of claim 1 comprising:
a) obtaining a fungal spore suspension and diluting the suspension to a spore density of 2.5×10⁶ spores/ml is attained;
b) inoculating the suspension of step (a) in PDA broth to make an inoculum;
c) incubating the inoculum for a period of 7-12 days in dark, whereby a mycelial mat is formed in the inoculum;
d) separating the mycelial mat from the inoculum;
e) obtaining an aqueous extract of the mycelial mat;
f) filtering the extract followed by sterilization of the extract thereby forming a biotic elicitor;
g) mixing 2.5×10⁻⁵ M (2.5 μM) abiotic elicitor selected from the group consisting of Methyl Jasmonate and Salicylic acid with 5×10⁻¹ to 10×10⁻¹ (0.5-1% w/v) ofthe biotic elicitor to obtain a mixture of biotic and abiotic elicitor;
h) diluting the mixture of step (g) with water to obtain the pungency enhancing composition.

8. The process as claimed in claim 7, wherein the biotic elicitor is obtained from an extract of Aspergillus niger, Aspergillus parasiticus or Rhizopus oligosporus.

9. The process as claimed in claim 8, wherein the extract is of Rhizopus oligosporus.

10. (canceled)

11. (canceled)

12. A method of enhancing pungency in fruit of Solanaceae family comprising applying a mycelial extract of a fungus selected from the group consisting of Aspergillus niger, Aspergillus parasiticus and Rhizopus oligosporus to a plant of Solanaceae family, wherein the extract enhances concentration of capasaicinoids and phenyl propanoid intermediates in the fruit, thereby enhancing pungency in the fruit.

13. The method as claimed in claim 12, wherein the fungus is Rhizopus oligosporus.

14. Use The method as claimed in claim 12, wherein capsaicin concentration is enhanced 3.25 fold to 10.55 fold in the fruit after applying the mycelial extract.

15. (canceled)

16. (canceled)

17. The composition of claim 1, wherein capsaicin concentration is enhanced in the fruits by 3.25 fold to 10.5 fold.
